(19) United States
(12) Patent Application Publication
(10) Pub. No.: US 2004/0245729 A1
(43) Pub. Date: Dec. 9, 2004

(54) Seal

(76) Inventors: Eberhard Bock, Morlenbach (DE); Thomas Klenk, Eppelheim (DE)

Correspondence Address: HARNESS, DICKEY & PIERCE, P.L.C., P.O. BOX 828, BLOOMFIELD HILLS, MI, 48303, US

(21) Appl. No.: 10/802,674

(22) Filed: Mar. 17, 2004

(30) Foreign Application Priority Data
Apr. 3, 2003 (DE) 10315333.0-12

(51) Int. Cl. F16J 15/32; F16J 15/08

(52) U.S. Cl. 277/569

(57) ABSTRACT

A seal for sealing rotating shafts, or rods that move back and forth, comprising a shaft-sealing or rod-sealing element that has a sealing surface or sealing edge. The sealing element is provided on at least one of its surfaces with a facing that consists of a nonvowen material impregnated with a polymer dispersion.

### CROSS-REFERENCE TO RELATED APPLICATIONS

This application claims the benefit of German Patent Application 103 15 333.0, filed Apr. 3, 2003. The disclosure of the above application is incorporated herein by reference.

### FIELD OF THE INVENTION

The invention relates to a seal for sealing rotating shafts or rods that move back and forth. The seal is provided with a sealing element including a sealing surface or sealing edge for sealing the shaft or rod.

### BACKGROUND OF THE INVENTION

In dynamic seals, because of their relative movement, the contact surfaces and the opposite surfaces are, in general, exposed to high thermal and mechanical stresses. Generally, polymeric materials such as elastomers, polyurethanes, or PTFE compounds are used to achieve good sealing. The elastomers and polyurethanes have outstanding elastic properties associated with an optimum capability to adapt themselves to the opposite surface. Thus, polyurethanes, because of their high resistance to wear and to tear propagation are used for hydraulic and pneumatic seals. Their high coefficient of friction values and low heat and chemical resistance, however, present problems. Further, PTFE compounds have very good sliding properties and excellent chemical and heat resistance, but they tend to creep, are hard, and do not adapt well to the opposite surface. For this reason, in a sealing system, elastomers and PTFE are often used together and bonded to each other. The elastomer takes over the task of elastically pressing the sealing edge or base against the opposite surface. The sealing edge itself consists of PTFE. Such a sealing edge, however, has the drawback of low adaptability at the microscopic level. Also, because of the low surface energy of the PTFE compound, adhesive bonding with the elastomer is possible only after expensive activation of the PTFE surface which leads to high costs and, in most cases as a result of such processing, causes considerable environmental pollution.

DE 102 06 624 discloses a seal wherein the sealing lip consists of a PTFE compound held on a polymeric material. Such a seal is well suited for many uses.

DD 113 608 discloses another possibility. Here, a PTFE facing is used in the region of the sealing lip. The facing is of low strength and is bonded with an elastomeric supporting element by vulcanization or welding.

DE 101 48 715 describes PTFE nonvowen materials as sealing elements in radial shaft seals.

Moreover, DE 198 39 502 C2 describes a design wherein the sealing ring is provided with at least two adjacent, axially separated sealing lips and wherein the first sealing lip facing the medium to be sealed consists of PTFE. With this arrangement, too, it is not possible to avoid the need to press the sealing lip made of PTFE against the shaft or piston rod with considerable pressure, thus subjecting it to wear and to simultaneous high heat generation.

The disclosures of the above prior art patent applications are hereby incorporated by reference in their entirety.

### SUMMARY OF THE INVENTION

The object of the invention is to provide an improved seal that is readily fabricated, has high mechanical resistance and, at the same time, exerts minimal friction.

This objective is reached by the present invention through a sealing element that is provided, on at least one of its surfaces, with a facing made of a nonvowen material impregnated with a polymer dispersion. The resulting polymer nonvowen material can be impregnated with a latex, or a PTFE, FEP or PFA dispersion. Experiments have shown that a PTFE-impregnated nonvowen material, in particular, gives unexpected, surprisingly good results in many respects. For example, frictional forces and wear resistance are clearly reduced. Further, high thermal and chemical resistance associated with good adaptability to the opposed surface were achieved at the same time. Also, no activation is needed for bonding the PTFE nonvowen material with the sealing element. More particularly, even without activation, sufficiently strong frictional and adhesive bonding was attained.

The material used as the PTFE nonvowen material consists of at least one layer of nonvowen material impregnated with a PTFE dispersion. The nonwoven layers consist of mechanically bonded nonvowen material with fiber lengths from 3 to 100 mm and particularly from 3 to 20 mm, and a weight per unit area from 20 to 500 g/m². The PTFE dispersion is an aqueous dispersion containing up to 50 wt. % of graphite, talc, mica or molybdenum disulfite, based on the dry weight of PTFE as an inorganic filler.

The facing can be bonded with the sealing element in many different ways. In the simplest case, the facing constitutes the sealing surface or sealing edge of the seal. The facing can then extend over the entire surface of the sealing element oriented toward the outside of the seal.

In another embodiment, the facing can be disposed on the surface of the sealing element oriented toward the outside and at a distance from the sealing surface or sealing edge. In this embodiment, at lower pressures, the seal is formed by the polymer sealing element itself, and only at higher pressures is the polymer sealing element more strongly pressed against the shaft or the rod so that only then the facing comes in contact with the shaft or the rod.

In another embodiment, the facing is used on the sealing element as an additional stiffening element. This can be accomplished, for example, by making the PTFE nonvowen material extend, starting from the sealing surface or sealing edge, over the entire radial length of the element surface directed toward the outside thereof. This results in considerable stiffening of the sealing element.

In the case of rod seals, it is possible to dispose the PTFE nonvowen material at a distance from the sealing surface or sealing edge, once again on the surface of the sealing element oriented toward the outside thereof. In this manner, too, considerable stiffening of the sealing element against extrusion is attained.

Finally, to achieve higher mechanical strength, it is possible to provide a facing on the surface of the sealing element oriented toward the inside thereof.

In addition to providing the sealing element with a facing consisting of a PTFE nonvowen material for sealing or stiffening purposes, it is also possible to provide the seal with a sealing lip for protection against dirt made of a PTFE nonvowen material.

If necessary, the sealing element may be provided with a spring element for pressing the sealing surface or sealing edge against the shaft or rod. In special application cases, it is also possible to position the PTFE nonvowen material facing on the dust lip or dust lips of the seal. This can be quite advantageous in cassette seals.

From a fabrication standpoint, it is advantageous to insert the PTFE nonvowen material into a recess of the sealing element. The PTFE nonvowen material is placed into the recess of the sealing element and held therein by friction alone. It is also possible, however, to glue the PTFE nonvowen material together with the sealing element, or to bond them by vulcanization.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a longitudinal cross-sectional view of the seal according to a principle of the present invention with a sealing surface resting on the shaft;

FIG. 2 shows a seal according to a principle of the present invention with a sealing edge resting on the shaft;

FIG. 3 shows a rod seal with a sealing edge according to a principle of the present invention;

FIG. 4 shows a rod seal with a sealing edge and stiffening of the sealing element according to a principle of the present invention;

FIG. 5 shows a rod seal with an O-ring as secondary seal and prestressing element according to a principle of the present invention;

FIG. 6 shows the use of a facing in a sliding seal according to a principle of the present invention;

FIG. 7 shows a shaft seal with a PTFE nonvowen material as a sealing edge and as a stiffening facing according to a principle of the present invention;

FIG. 8 shows a rod seal with a strengthening facing disposed on the surface of the sealing element oriented toward the outside according to a principle of the present invention;

FIG. 9 shows a cross-section of a shaft seal with a facing of a PTFE nonvowen material displaced toward the sealing edge and, for protection against dirt, a sealing lip made of a PTFE nonvowen material according to a principle of the present invention;

FIG. 10 shows a shaft seal with a spring element made of an elastomer according to a principle of the present invention;

FIG. 11 shows a seal with a PTFE nonvowen material and steel spring according to a principle of the present invention; and

FIG. 12 shows an application of the principles of the present invention to a cassette seal.

### DETAILED DESCRIPTION OF THE PREFERRED EMBODIMENTS

The following description of the preferred embodiments is merely exemplary in nature and is in no way intended to limit the invention, its application, or uses.

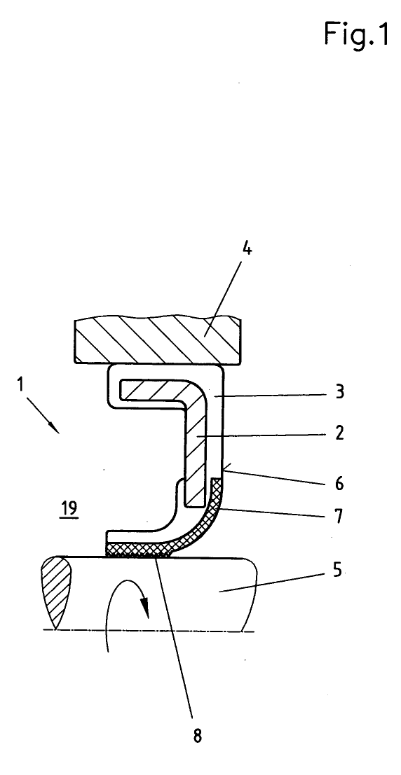

FIG. 1 shows schematically a radial shaft seal 1 consisting of a stiffening ring 2 with an elastomer 3. With the aid of elastomer 3, the seal 1 is fastened to a housing 4. On a part of elastomer 3 facing a shaft 5, the sealing element formed by elastomer 3 is provided, on its surface 6 that is oriented outward, with a facing 7 made of a PTFE nonvowen material. Facing 7 is provided on a sealing surface 8 with a structure for returning a lubricant oil to inner space 19.

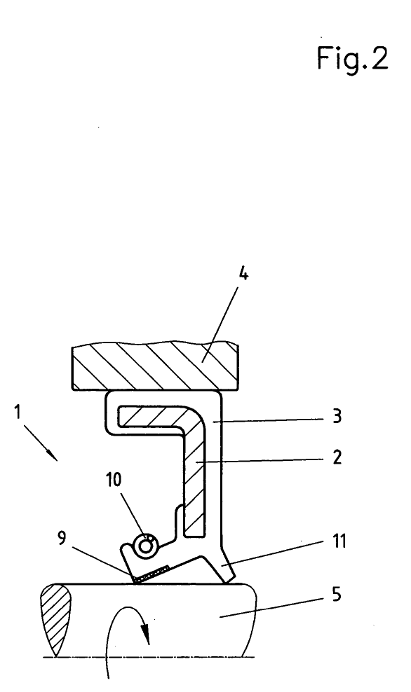

FIG. 2 shows a seal 1 wherein the sealing element 3 has a sealing edge 9. A coil spring 10 additionally presses the sealing edge 9 against the shaft 5. Moreover, the sealing element 3 is provided with a dust lip 11.

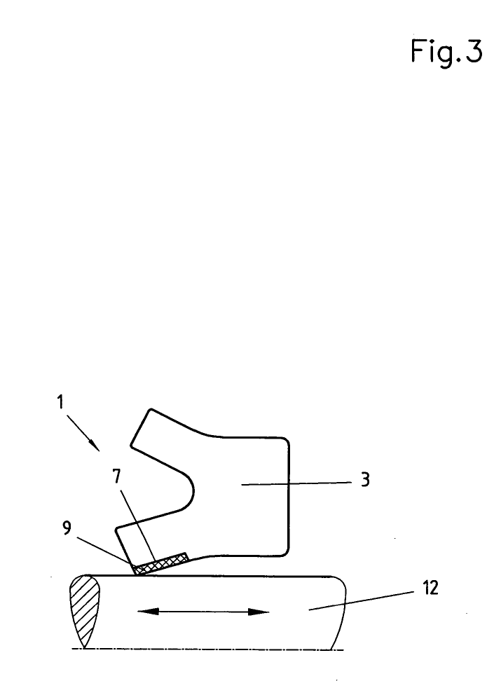

FIG. 3 shows a design of the sealing edge 9, comparable to that of FIG. 2, but for a rod seal. The sealing edge 9 is disposed on sealing element 3 and is pressed against rod 12.

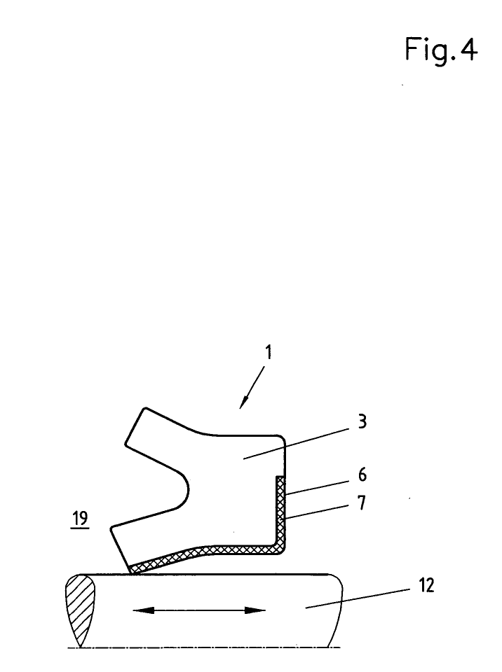

In the embodiment of FIG. 4, the sealing element 3 is provided with a facing 7 that extends over the entire outer side 6 of sealing element 3. This results in considerable stiffening of the entire sealing element 3. At high pressures in the inner space 19, in particular, such a seal is advantageous because the facing 7 provides additional protection against gap extrusion.

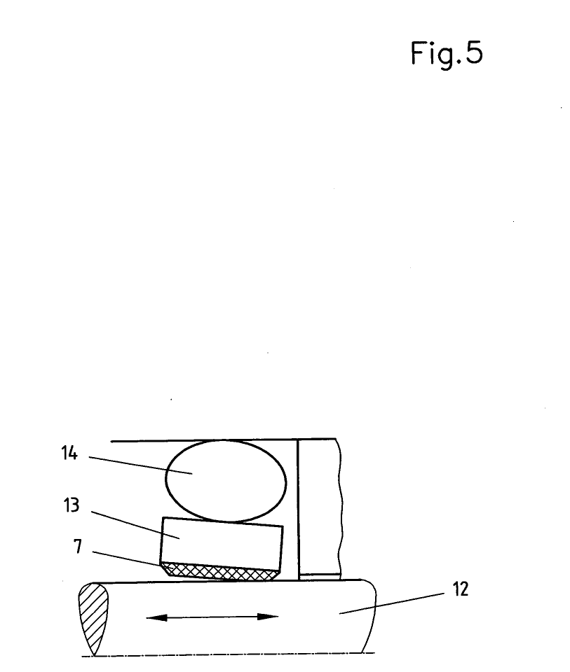

FIG. 5 shows another application in which a sealing ring 13 consisting of a polymer is provided with a facing 7 that rests on the rod 12. An O-ring 14 presses the polymer ring 13 against the rod 12.

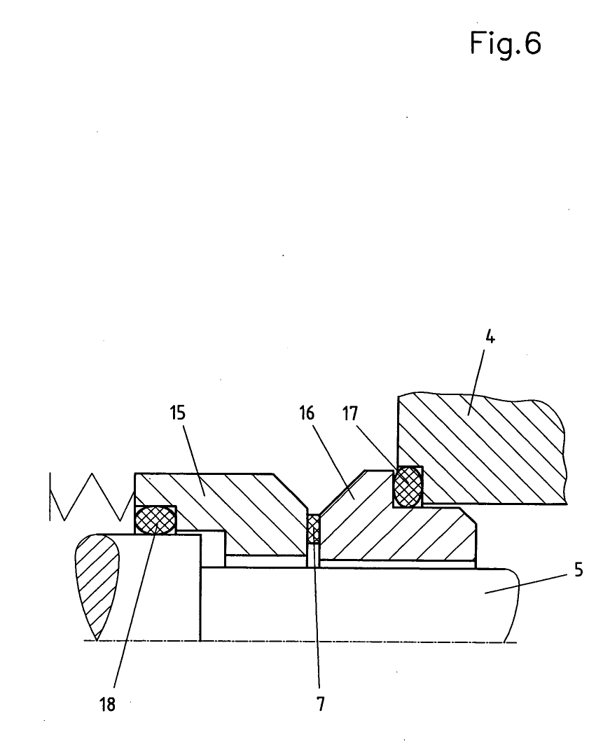

FIG. 6 shows the use of the facing 7 in a sliding seal. Here, a ring 15 is provided with the facing 7, which is in sliding contact with another ring 16. Rings 15 and 16 are sealed against a housing 4 and shaft 5 by seals 17 and 18.

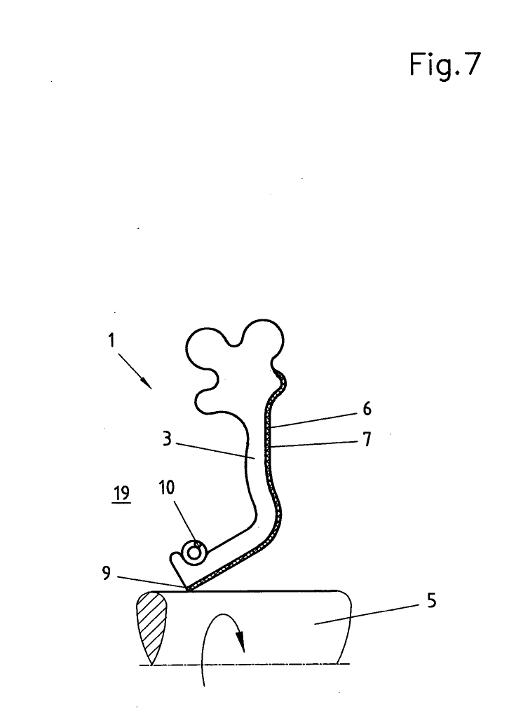

FIG. 7 shows an embodiment wherein the facing 7 extends essentially over the entire surface 6 of the sealing element 3. A sealing edge 9 is also provided and is pressed against the shaft 5. To this end, the sealing element 3 is assisted by a spring 10. In case of higher pressure prevailing on the inside 19 of the seal 1, the facing 7 acts as a stiffening member for the sealing element 3.

Another possible way of stiffening the sealing element 3 is achieved by having the elastomeric sealing element 3 form the sealing edge 9, and by applying the facing 7 to a surface of the sealing element 3 that is oriented toward the inside 19 of seal 1. The facing 7 disposed in this manner contributes to the stiffening of sealing element 3 to a high degree. In this manner, it is also possible to achieve good sealing with sealing lip 9 whose wear resistance can, of course, be additionally improved by inserting a facing 7 in the region of the sealing lip 9.

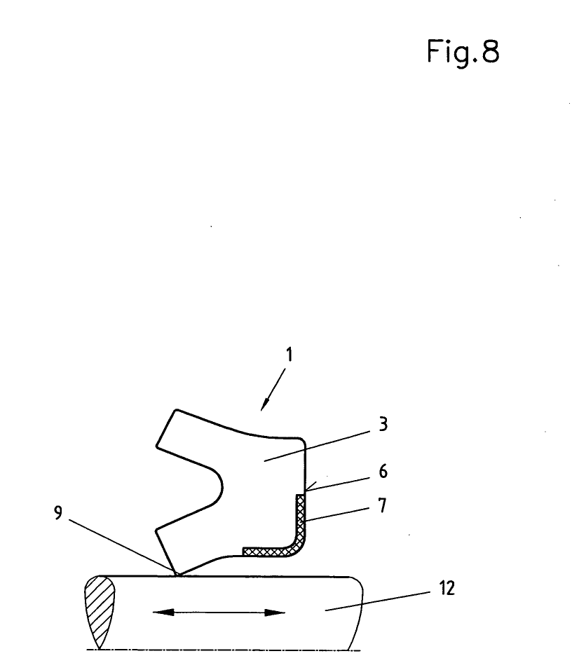

FIG. 8 shows a rod seal 1 wherein the sealing element 3 is provided with a sealing lip 9 resting on the rod 12. The facing 7 is used as a reinforcement at a surface 6 of the sealing element 3 that is oriented outward so as to reduce the gap extrusion of the sealing element 3.

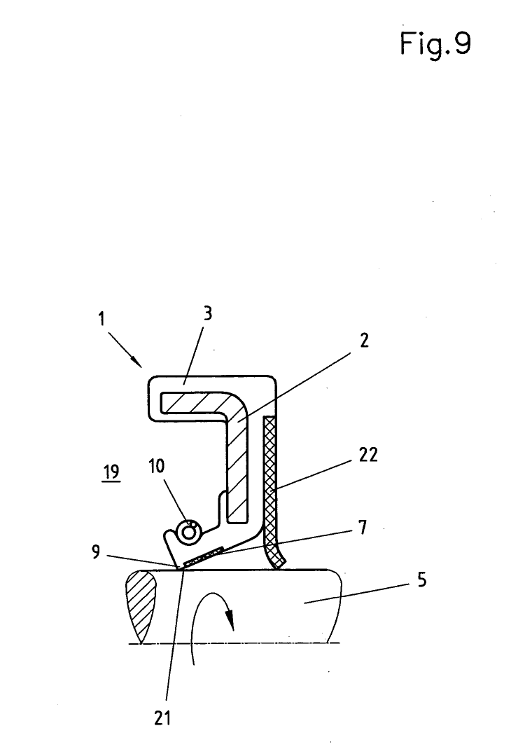

In the event of pressure being exerted from inner space 19, by means of the embodiment of seal 1 shown in FIG. 9, good sealing combined with good protection against wear is achieved by use of a sealing edge 9 made of an elastomer. The sealing element 3 is provided with a supporting ring 2 and has a sealing lip 9 that rests directly on the shaft 5. At a small distance 21 from the sealing edge 9, a facing 7 is inserted into the sealing element 3. Preferably, the facing comes into contact with the shaft 5 only at higher pressures in the inner space 19. During operation at lower pressures, the sealing edge 9 made of the elastomeric material is pressed against the shaft 5 by the sealing element 3 and additionally by a coiled spring 10. At higher pressures in the inner space 19, the sealing element 3 arches in the direction of the shaft 5 so that the facing 7 makes contact with the shaft 5. As a result, despite the higher pressures in inner space 19, the frictional forces and the wear between the sealing element 3 and the shaft 5 are reduced compared to a direct sealing by the elastomeric sealing edge 9. In the example shown, the seal 1 is provided with a sealing lip 22 for protection against dirt, wherein the lip 22 also consists of a PTFE nonvowen material.

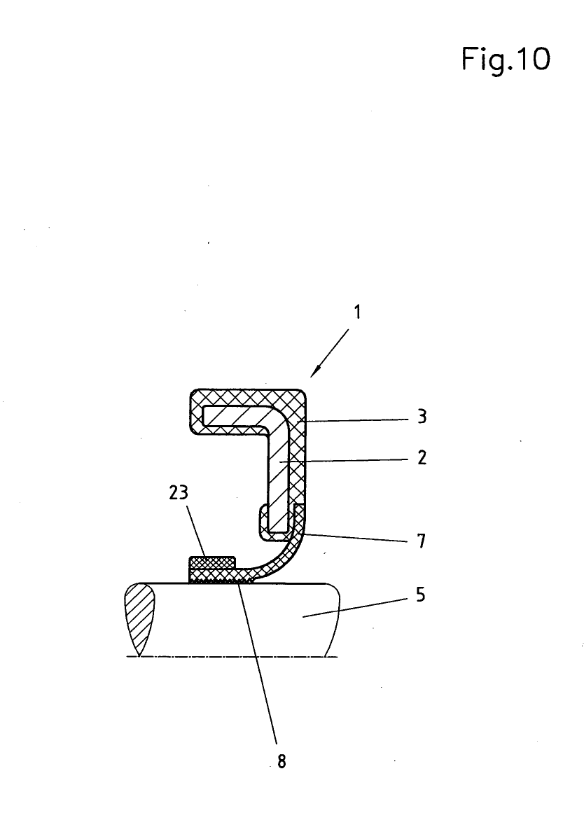

In the design according to FIG. 10, a sealing ring 2 is provided with a facing 7 that is fastened to the sealing element 3 only with its radially outer end. The end of the facing 7 that is positioned radially inside rests as a sealing surface 8 on the shaft 5. To ensure reliable sealing at the shaft 5, despite partially absent support for the facing 7, the facing 7 can be provided at the radially inner end thereof with a spring element 23 that presses the radially inner end against the shaft 5.

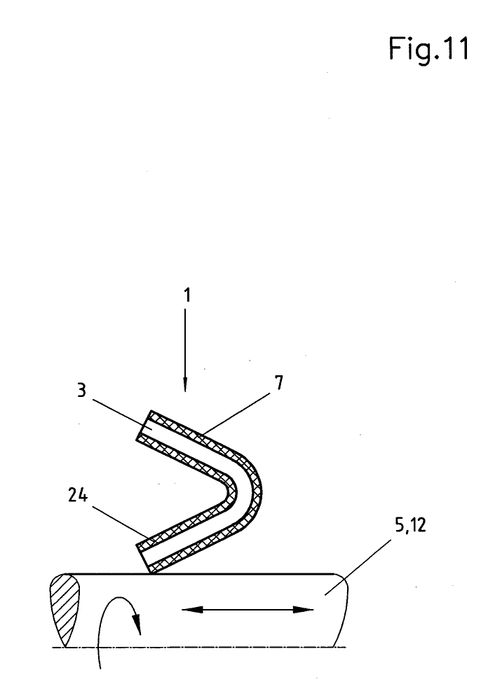

FIG. 11 shows an embodiment in cross-section of a seal 1 provided with a V-shaped spring element 24. On its outward oriented surface, the sealing element 3 is completely fitted with a facing 7.

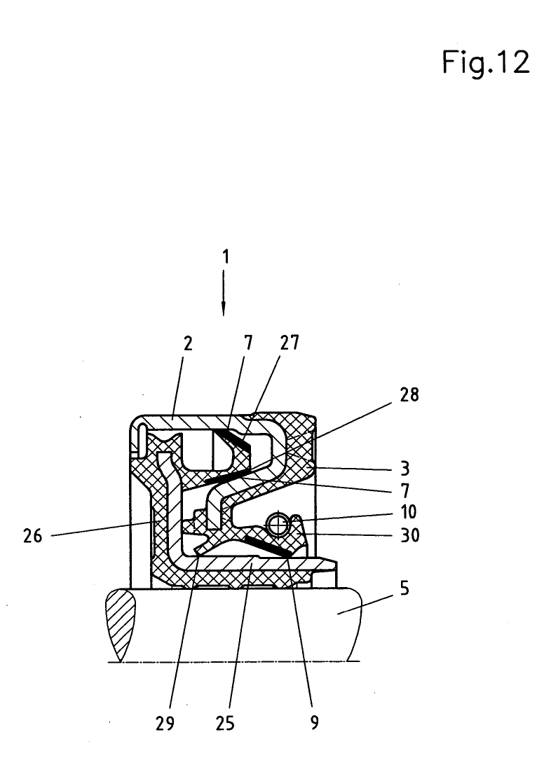

The seal 1 can be used to great advantage in a cassette seal as shown in FIG. 12. The cassette seal 1 shown in the figure consists of an outer ring with a supporting ring 2, and of sealing element 3 with a sealing edge 9. The sealing edge 9 is pressed against the running surface of inner ring 25 by a lip 30 of the sealing element 3. The inner ring 25 is fastened on a shaft 5 by its own sealing element 26. The inner ring 25 is also provided with dust lips 27 and 28, each of which are provided with a facing 7 made of PTFE nonvowen material. The dust lips 27 and 28 slide on the internal surfaces of supporting ring 2. In addition, the sealing element 3 also has a dust lip 29 which, if needed, can be fitted with a facing 7.

It should be understood that the facing 7 can be fastened to a sealing element 3 in various ways. For example, the facing 7 can be placed into an appropriate recess, for example as shown in FIGS. 1, 2, 3, 4, 8, 9, 10 and 13. The facing 7 is held in the recess by friction. It is also possible, however, to bond the facing 7 with the sealing element 3 by vulcanization or gluing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A seal for sealing rotating shafts, or rods that move back and forth, comprising a sealing element for said shaft or said rod, said sealing element fitted with a sealing surface or a sealing edge, wherein said sealing element is provided on at least one of its surfaces with a facing including a nonvowen material impregnated with a polymer dispersion.

2. The seal according to claim 1, wherein the nonvowen material is impregnated with at least one polymer dispersion selected from the group consisting of latex, PTFE, FEP, and PFA.

3. The seal according to claim 1, wherein the facing forms the sealing surface or the sealing edge.

4. The seal according to claim 1, wherein the facing extends over the entire surface of the sealing element and is oriented toward an outside of the seal.

5. The seal according to claim 1, wherein the facing is disposed on a surface of the sealing element and is oriented toward an outside of the sealing element at a distance from the sealing surface or the sealing edge.

6. The seal according to claim 1, wherein the seal has a lip for protection against dirt, said lip consisting of a PTFE nonvowen material.

7. The seal according to claim 1, wherein the sealing element is provided with a spring element for pressing the sealing surface or the sealing edge against the shaft or the rod.

8. The seal according to claim 6, wherein the PTFE nonvowen material is placed on a plurality of dust lips of the seal.

9. The seal according to claim 1, wherein a PTFE nonvowen material is placed into a recess of the sealing element.

10. The seal according to claim 9, wherein the PTFE nonvowen material placed into the recess of the sealing element is held therein by friction.

11. The seal according to claim 1, wherein a PTFE nonvowen material is glued to the sealing element or is bonded thereto by vulcanization.

12. The seal according to claim 1, wherein the nonvowen material consists of at least one layer of a nonvowen material impregnated with a PTFE dispersion.

13. A seal comprising:
a stiffening ring;
a sealing element formed of an elastomer disposed on the stiffening ring; and
a facing disposed on an outer surface of the sealing element, the facing formed on a nonwoven material impregnated with a polymer.

14. The seal according to claim 13, wherein the sealing element includes a sealing edge and a dust lip, the facing being disposed on the sealing edge.

15. The seal according to claim 14, further comprising a coil spring that presses the sealing edge against a shaft or a rod to be sealed.

16. The seal according to claim 13, wherein the facing extends over an entire outer surface of the sealing element.

16. The seal according to claim 13, wherein the facing is a stiffening member.

17. A cassette seal comprising the seal according to claim 13.

18. A sliding seal comprising a first ring with a facing, the facing comprised of a nonwoven material impregnated with a polymer and in sliding contact with a second ring, wherein the first ring and second ring are sealed against a housing and a shaft or rod.
